(19) United States
(12) Patent Application Publication
(10) Pub. No.: US 2026/0310982 A1
(43) Pub. Date: Oct. 8, 2026

(54) UTILIZING A GENERATIVE MODEL AS A PARTIAL WORLD MODEL TO REDUCE SEARCH SPACE FOR LONG-HORIZON TASKS

(71) Applicant: GDM Holding LLC, Mountain View, CA (US)

(72) Inventors: Gheorghe Comanici, Montreal (CA); Doina Precup, Montreal (CA); Fei Xia, Menlo Park, CA (US); Aleksandra Faust, Palo Alto, CA (US); Khimya Khetarpal, Seattle, WA (US)

(21) Appl. No.: 19/464,086

(22) Filed: Jan. 29, 2026

Related U.S. Application Data
(60) Provisional application No. 63/751,753, filed on Jan. 30, 2025.
(60) Provisional application No. 63/751,932, filed on Jan. 31, 2025.
(60) Provisional application No. 63/970,812, filed on Jan. 29, 2026.

(51) Int. Cl. G06N 3/092

(52) U.S. Cl. CPC G06N 3/092

(57) ABSTRACT

Implementations are directed to utilizing a generative model as a partial world model to reduce a search space in a search and planning process for long-horizon tasks. Some of those implementations reduce the search space by leveraging, at one or more iterations of the search and planning process, a generative model to process a corresponding state observation (e.g., a current state observation at an initial iteration) to generate corresponding output that reflects a corresponding subset, of defined actions of an agent, as feasible actions for the corresponding state observation—and restricting the search and planning process to utilizing only the corresponding subset of the actions at the one or more iterations. For example, as opposed to processing, in an iteration of the search and planning process, all possible actions of an agent, implementations instead process only the subset of the actions determined to be feasible.

### BACKGROUND

Prior techniques for planning long-horizon tasks for agents operating in an environment have relied on learning world models from data for the environment, either online through interaction with a simulated environment or offline using existing datasets. Such approaches often suffer from high sample complexity, requiring extensive data collection and/or pre-existing datasets of sufficient size and quality. Furthermore, the learned models may not generalize well to unseen situations or tasks (e.g., may not generalize to novel environment(s)). Some recent techniques have explored using large language models (LLMs) as full world models, leveraging the vast knowledge based on which LLMs are trained. However, directly employing LLMs as full world models, in predicting future states for all possible state-action pairs in complex environments, is computationally burdensome and/or leads to inaccurate predictions.

For example, employing LLMs as full world models, in a search and planning process for long-horizon tasks, can result in exploring actions without explicitly considering the feasibility or relevance of those actions. Failing to explicitly consider the feasibility or relevance of actions can result in inefficient exploration of the state-action space and suboptimal planning. For example, the search and planning process can process, in an initial iteration and using an LLM, a current state and all possible actions of an agent, to generate output that reflects actions to explore. However, that output can indicate that an action should be explored despite that action being infeasible in the current state and/or despite that action being feasible, but suboptimal. This can be due to treating the LLM as a full world model and processing all available agent actions utilizing the LLM. Put another way, processing all possible actions of the agent at each iteration of the exploration can lead to undesirable actions being explored and/or desirable actions being overlooked in exploration.

More generally, prior techniques struggle with the difficulty of accurately modeling complex environments and with the computational cost of searching through vast state-action spaces. For example, they can struggle with sample efficiency, generalization to new tasks, and/or the efficient integration of large-scale knowledge representations found in LLMs.

### SUMMARY

Implementations disclosed herein are directed to utilizing a generative model as a partial world model to reduce a search space in a search and planning process for long-horizon tasks. The generative model can be, for example, a trained LLM, a trained vision-language model (VLM, such as Flamingo: a VLM for Few-Shot Learning), or a trained multi-modal input and output model (e.g., Gemini). Some of those implementations reduce the search space by leveraging, at one or more iterations of the search and planning process, a generative model to process a corresponding state observation (e.g., a current state observation at an initial iteration) to generate corresponding output that reflects a corresponding subset, of defined actions of an agent, as feasible actions for the corresponding state observation—and restricting the search and planning process to utilizing only the corresponding subset of the actions at the one or more iterations.

For example, as opposed to processing, in an initial iteration of the search and planning process, all possible actions of an agent (along with a current state and a task), implementations instead process only the subset of the actions, determined to be feasible actions for the current state, in determining action(s) to explore in the initial iteration. For instance, the subset of the actions can be determined based on output generated from processing, using a generative model, a first prompt that includes the current state, that includes all of the actions, and that lacks any description of a task to be performed. Further, in the initial iteration of the search and planning process a further subset of action(s) to explore can be determined based on output generated from processing, using the generative model, a second prompt that includes the current state, that includes the subset of the actions, that includes description of the task to be performed, and that lacks any of the actions not included in the subset.

In these and other manners, the generative model is leveraged to guide the search and planning process to focus only on task-agnostic actions from the corresponding subset of the defined task-agnostic actions that are feasible for the corresponding state observation and to avoid any processing of other of the defined task-agnostic actions that are not from the corresponding subset (i.e., determined infeasible for the corresponding state observation). Reducing the search space can result in quicker resolution of a sequence of actions to accomplish a task and/or can result in a sequence of actions that accomplish the task more efficiently (e.g., less steps) and/or that are more likely to be successful (e.g., more likely to achieve a task objective). The more efficient and/or reliable sequence of actions can be generated by restricting iteration(s) to feasible actions, thereby preventing consideration and/or inclusion of infeasible actions in a sequence of actions.

Some implementations disclosed herein are directed to obtaining a state observation that reflects a current state of an environment of an agent. A prompt including the state observation is generated and processed by a generative model to generate output that reflects a subset of actions performable by the agent. The subset of the actions, reflected by the output, can be the actions that are feasible in the current state, as determined based on processing the prompt. The actions in the subset are then utilized, without utilizing any actions not in the subset, in an initial iteration of a task-specific search and planning process that seeks to determine a sequence of actions for causing performance of the task. The determined sequence of actions can be referred to as task-specific actions. The agent is then caused to perform the sequence of actions determined from the search and planning process. For example, command(s) can be sent to the agent to cause it to perform the determined sequence of actions.

Some of those and/or other implementations disclosed herein can mitigate (e.g., eliminate) various drawbacks with current techniques. For example, by leveraging a generative model to identify a subset of actions before initiating a search and planning process, the computational burden associated with exploring all possible actions is reduced, addressing the intractability and/or other drawbacks of using LLMs as full world models. As another example, focusing the search and planning process on only the feasible actions identified by the generative model improves the accuracy of the planning process by preventing consideration of infeasible actions. As another example, the utilization of various techniques disclosed herein allows for generalization across related tasks, improving sample efficiency and reducing the need for extensive data collection for each new task.

In some of those implementations, the prompt that is processed in determining the subset of actions can include, along with the state observation, all defined actions for the agent, such as natural language descriptions for each action. Optionally, the prompt further includes one or more few-shot examples reflecting example state observations and corresponding feasible actions for the example state observations. For example, if the actions include “move block A to location X,” “move block B to location Y,” and “stack block A on block B,” the prompt might list these actions and provide examples like: “State: Block A is at location P, Block B is at location Q. Feasible actions: move block A to location X, move block B to location Y.” The state observation itself can optionally include (e.g., be restricted to) a natural language description of the environment and/or can include vision data and/or other sensor data capturing the environment (e.g., when the generative model processes multimodal input). The agent can be, for example, a robotic arm in a simulated or real-world environment, or a software application interacting with other software or the operating system.

In certain implementations, the task-specific search and planning process includes utilization of a Monte Carlo Tree Search (MCTS) algorithm. The search space in the initial iteration is restricted to the subset of actions determined based on the prompt that includes the current state, and subsequent iterations can further refine the search space using additional prompts and generative model outputs. For instance, after an initial iteration identifies “move block A to location X” as feasible, a subsequent iteration might generate a subsequent prompt that includes the next state that is predicted to result from implementing “move block A to location X”. The subsequent prompt can be processed to generate output that reflects an additional subset of the actions that are feasible given the next state. In view of differences between the current state and the predicted next state, the additional subset of the actions can vary from the subset of the actions. The additional subset of the actions can then be utilized, without utilizing any actions not in the additional subset, in further iteration of a task-specific search and planning process. The further iteration can be one that explores action(s) to apply in the predicted next state in performance of the task. For example, in the further iteration the action(s) to explore can be determined based on processing a further prompt that includes the predicted next state, includes the description of the task, includes the actions of the additional subset, and excludes any actions not in the additional subset.

Put another way, additional prompts can be generated based on the predicted next state from the previous iteration, allowing the system to adapt to changes in the environment and refine its search. This adaptive approach ensures that the search remains focused on feasible actions throughout the planning process. The final sequence of actions to be implemented can be determined based on a reward generated by the search and planning process. For example, the final sequence of actions can be selected based on the reward satisfying one or more specific criteria such as satisfying an absolute threshold and/or a relative threshold that is relative to the reward for other sequence(s) of actions being considered.

As a non-limiting example of some implementations disclosed herein, consider a robotic arm tasked with stacking blocks on a tabletop. The system obtains a current state observation, such as an image of the tabletop showing three blocks: a red block (A), a blue block (B), and a green block (C), with block A positioned to the left of block B, and block C positioned to the right of block B. A prompt is generated, which includes this state observation (e.g., “Image depicting three blocks: red (A), blue (B), green (C), with A left of B, C right of B”) and a list of defined actions that can be performed by the robotic arm such as: “pick up block X,” “place block X at location Y,” “stack block X on block Y.” This prompt is processed using an LLM, which generates output indicating that “pick up block X,” and “place block X at location Y,” are feasible actions in the current state, while “stack block X on block Y” is not feasible. An MCTS-based search and planning process then uses only these feasible actions in an initial iteration of determining initial action(s) to explore in determining a sequence of actions. In a further iteration of determining next action(s) to explore, a prompt is generated that includes a next state observation and the list of defined actions for the robotic arm. The next state observation can be one predicted to follow one of the initial action(s). For example, the next state observation can be one determined from a simulated state following simulation of the initial action from the current state or can be one determined based on processing the initial action and the current state using a generative model (e.g., the LLM). For instance, the next state observation can be based on output generated based on processing, using a generative model, of the current state, the initial action, and, optionally, one or more few shot examples. This prompt that includes the next state is processed using the LLM, which generates further output indicating feasible actions in the next state, which could be different from those determined feasible in the current state. The MCTS-based search and planning process then uses only these feasible actions in the next iteration of determining next action(s) to explore in determining the sequence of actions. This general process can be repeated, for each “next state” explored, until the sequence of actions is determined.

The above description is provided as an overview of some implementations of the present disclosure. Further description of those implementations, and other implementations, are described in more detail below.

### BRIEF DESCRIPTION OF THE DRAWINGS

FIG. 1 illustrates an example environment in which implementations disclosed herein can be implemented.

FIG. 2 is a flowchart illustrating an example method according to various implementations disclosed herein.

FIG. 3 schematically depicts an example robot, in accordance with various implementations.

FIG. 4 schematically depicts an example architecture of a computer system.

### DETAILED DESCRIPTION

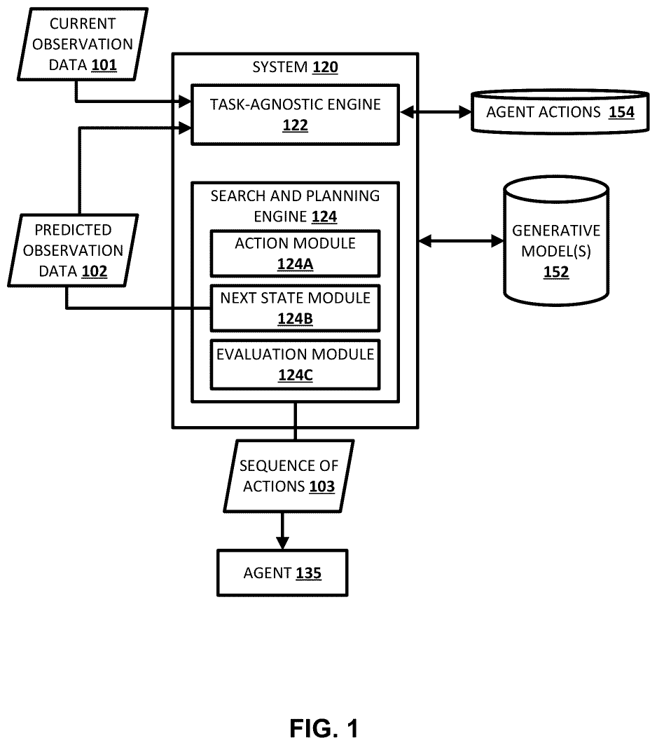

FIG. 1 illustrates an example environment in which implementations disclosed herein can be implemented. The example environment of FIG. 1 includes a system 120 that can interact with (or include in some implementations) an agent 135, one or more generative models 152, and/or other component(s). The system 120 of FIG. 1 is illustrated as including a task-agnostic engine 122 and a search and planning engine 124.

The task-agnostic engine 122 can generate prompts that include observation data and that exclude any description of a task to be performed by the agent 135. In an initial iteration of generating a sequence of actions for the agent 135 to implement in performing a task, the observation data can be current observation data 101 that reflects a current state of an environment of the agent 135. In subsequent iterations of generating a sequence of actions for the agent 135 to implement in performing a task, the observation data can be corresponding predicted observation data that is generated by search and planning engine 124 and that reflects a corresponding predicted state of the environment that would result from application of an action being explored by the search and planning engine 124. The task-agnostic engine 122 can cause a generated prompt to be processed using one of the generative model(s) 152 to generate task-agnostic output that reflects, for multiple actions that are performable by the agent 135, a subset of the actions. The task-agnostic engine 122 can cause the subset of the actions to be provided to the search and planning engine 124 and can cause the search and planning engine 124 to utilize the actions of the subset, without utilizing any actions that are not from the subset, in iteration(s) of a task-specific search and planning process.

The search and planning engine 124 is illustrated as including an action module 124A, a next state module 124B, and an evaluation module 124C. The action module 124A utilizes output from the task-agnostic engine 122 to determine which action(s) to explore. For example, the action module 124A, in the initial iteration of search and planning, can generate an additional prompt that includes the current observation data 101, that includes a description of the task to be performed by the agent 135, and that includes description of the actions of the subset output by the task-agnostic engine 122. The action module 124A can cause that additional prompt to be processed by one of the generative model(s) 152, to generate output that reflects a further subset of actions, and the actions of the further subset can be the ones explored for the initial iteration.

The next state module 124B utilizes output from the action module 124A to determine, for each of the actions, a corresponding predicted next state that is predicted to occur responsive to a corresponding action being performed. For example, the next state module 124B, in an initial iteration of search and planning, can process an action and the current observation data 101 using one of the generative model(s) 152, to generate output that reflects a next state that is predicted to result from application of the action in the current state reflected by the current observation data 101. For subsequent iterations of search and planning, the next state module 124B can process an action and predicted observation data 102 of a predicted next state, generated in a prior iteration, using one of the generative model(s) 152, to generate corresponding output that reflects a further predicted next state. The predicted next state is predicted to result from application of the action in the predicted next state of the prior iteration.

The evaluation module 124C can utilize output from the action module 124A, the next state module 124B, and/or one or more other criteria in determining a sequence of action(s) 103 to be implemented by the agent 135 in performance of a task. Put another way, the evaluation module 124C can evaluate different sequences of actions explored by the search and planning engine 124 and can select one of those sequences to implement. In some implementations, the evaluation module 124C utilizes reward data generated by the search and planning engine 124 in selecting the sequence of action(s) 103. In some of those and/or other implementations, the search and planning includes MCTS-based searching. In some implementations, the evaluation module 124C utilizes a reward model that is distinct from the generative model used to predict the next state. By decoupling the reward evaluation from the state prediction, the system ensures that the search and planning process is not biased by a generative model that might otherwise hallucinate task completion in an inaccurate predicted state.

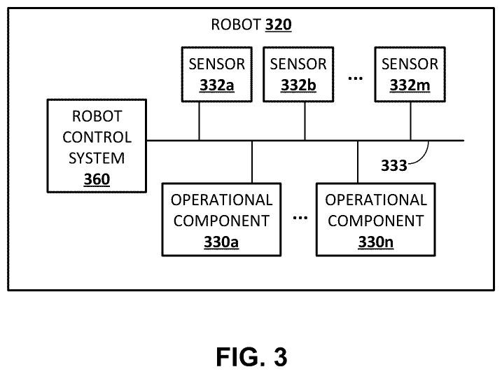

The agent 135 can be any of a variety of different types of agents. For example, the agent 135 can be a robot (e.g., the robot 320 of FIG. 3) that can perform various tasks in a physical or simulated environment. As another example, the agent 135 can be a software program that interacts with other software or with an operating system.

The generative model(s) 152 can be any of a variety of different types of generative model(s) such as LLM(s), VLM(s), and/or other multi-modal model(s). In some implementations, a generative model can optionally be adapted or fine-tuned to align a general pre-training objective (e.g., next-token prediction) with a world-modeling objective. In some of those implementations, the generative model is subjected to low-rank adaptation (LoRA) or other parameter-efficient fine-tuning technique(s) using a dataset of agent-environment interactions. This adaptation can optimize the generative model's ability to identify feasible task-agnostic actions and predict physical transition dynamics, thereby enhancing the accuracy of the partial world model without requiring a full retraining of the generative model's large-scale knowledge representation.

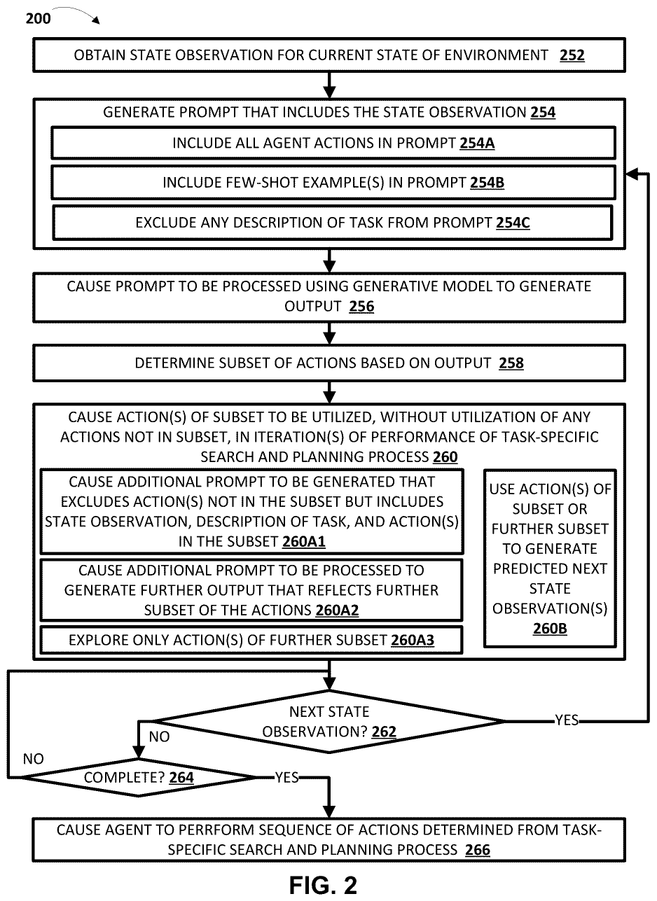

FIG. 2 is a flowchart illustrating an example method 200 according to various implementations disclosed herein. For convenience, the operations of the method of FIG. 2 (or any other method disclosed herein) are described as being performed by a system, such as system 120 (see FIG. 1). This system can include one or more processors and/or other component(s) of a server or other computing device. Moreover, while operations of the method of FIG. 2 are shown in a particular order, this is not meant to be limiting. One or more operations may be reordered, omitted or added.

At block 252, the system obtains a state observation that reflects a current state of an environment of an agent. For example, the state observation can include recent image(s) captured by camera(s) of a robot agent, a natural language description of a current environment of the robot agent, and/or description of classification(s) and location(s) of object(s) detected in an environment of the robot agent. As another example, the state observation can include screenshot(s) of screen(s) currently and/or recently rendered by a software application, DOM tree(s) for a current and/or recent state of a software application, and/or a natural language description of a current and/or recent state of the software application.

At block 254, the system generates a prompt that includes the state observation. For example, the state observation included in the prompt can include a textual description of the current state. As another example, the state observation can additionally or alternatively include vision data, audio data, other sensor data, or multiple types of data (e.g., vision, audio, and other sensor data) that capture the current state of the environment. The system can optionally include, in the prompt, natural language that requests outputting of all agent actions that are feasible based on the state observation. In some implementations, block 254 includes sub-block 254A, sub-block 254B, and/or sub-block 254C.

At optional sub-block 254A, the system generates the prompt to further include all defined actions of the agent. The defined actions can be stored by a memory of the system and/or retrieved by the system from the memory.

At optional sub-block 254B, the system generates the prompt to further include one or more few-shot examples. For example, the one or more few-shot examples can each include an example state observation and corresponding subset of the defined actions that have been previously determined to be feasible based on the example state observation.

At optional sub-block 254C, the system generates the prompt such that it excludes any description of a task to be performed by the agent based on method 200. For example, if the task is a robotic task to stack all blocks in an environment atop one another, the prompt can lack any description of that task. As another example, if the task is a task to automatically control a computer application to achieve a certain state within the computer application, the prompt can lack any description of that task.

In some implementations, the system generates the prompt to incorporate natural language descriptions of physical invariances or constraints associated with the agent (e.g., “a gripper cannot grasp an object if another object is stacked on top of it” or “an object is only movable if it is visible”). By explicitly including these task-agnostic rules in the prompt, the system enables processing, utilizing the generative model, to infer the subset of feasible actions by applying the rules to the current state observation. This captures global invariances that apply across different tasks and environments, allowing the agent to generalize the determination of feasible actions without requiring extensive retraining for each specific task configuration.

At block 256, the system causes the prompt to be processed, using a generative model, to generate output. The output can reflect a subset of the defined actions of the agent (e.g., a subset of those included in the prompt at optional sub-block 254A). For example, the defined actions can include 25, 30, 50, or other number of actions and the output can reflect only a subset of those (e.g., only 5 of 25 defined actions). The subset of the defined actions that are reflected by the output can be those that have been determined, based on the processing using the generative model, to be feasible given the state observation. Put another way, the subset of the actions that are reflected in the output can be those that have been determined to be achievable actions given the state observation, without regard to whether such actions would be beneficial in achieving a task to be performed by the agent based on method 200.

At block 258, the system determines a subset of the defined actions based on the output. For example, output that is generated from processing the prompt at block 256 can reflect a sequence of probability distributions over tokens, and that output can be decoded to generate a natural language description and/or other content that describes the subset of the defined actions without describing any of the actions not included in the subset.

As another example, the output can reflect a sequence of probability distributions over tokens, and that output can be decoded to generate a natural language description and/or other content that describes all of the defined actions and, for each of the defined actions, a corresponding measure (e.g., a probability) indicating a degree of feasibility of the defined action in view of the current state and task. The corresponding measure(s) can then be utilized to determine the subset of the defined actions. For example, only the subset of the defined actions with corresponding measures (e.g., probabilities) that satisfy one or more criteria (e.g., satisfying a threshold and/or relative threshold) can be determined at block 258 to be the subset of the defined actions.

In some implementations, the system may assign a non-zero recovery probability to actions not included in the subset. This allows the search and planning process to occasionally explore atomic actions outside of the determined affordances, thereby mitigating planning failures in instances where the generative model output potentially excludes a task-relevant action due to model bias or intent misspecification.

In some implementations, the non-zero recovery probability (or exploration parameter) that is assigned to actions not included in the subset can be dynamically tuned to balance a trade-off between search efficiency and task completeness. In some implementations, this probability is determined based on an estimated horizon of the task and/or based on a quantity of chained affordances required (e.g., adjusting the probability such that it remains below an inverse of the number of steps). In implementations that utilize a tunable probability of selecting atomic actions outside the determined subset, the system prevents potential planning failures caused by mis-specified intents or model bias, ensuring that the agent can recover if the generative model incorrectly excludes a necessary action while still maintaining a bound on the sampling time.

In some implementations, determining the subset of defined actions can include distinguishing between task-agnostic actions (or distribution-robust agent actions) and task-specific actions. Task-agnostic actions can be based on internal dynamic(s) of the agent, such as the physical constraints of a robot agent (e.g., a gripper's ability to grasp an object regardless of the object's color). Conversely, task-specific actions can capture constraints imposed by the physical workspace or a specific distribution of tasks (e.g., placing a block inside a bowl, which is only feasible in specific environmental configurations). By utilizing the generative model to identify task-agnostic actions, the system can induce a partial world model that generalizes across a distribution of related tasks. This allows the agent to transfer knowledge regarding its own embodiment across different tasks, thereby improving learning speed and/or search efficiency without requiring the generative model to relearn an agent's basic capabilities for each new task.

At block 260, the system causes action(s) of the subset to be utilized, without utilization of any actions that are not in the subset, in one or more iterations of a task-specific search and planning process. For example, in an initial iteration of block 260 the system can cause action(s) of the subset, of an initial iteration of block 258, to be utilized and in a next iteration of block 260 the system can cause action(s) of the subset, of a next iteration of block 258, to be utilized. The search and planning process is used to determine a sequence of actions for the agent to perform in order to accomplish a task. In some implementations, the task-specific search and planning process includes a Monte Carlo Tree Search (MCTS)-based search process. In some implementations, block 260 includes sub-block 260A1, sub-block 260A2, sub-block 260A3, and/or sub-block 260B.

At sub-block 260A1, the system causes an additional prompt to be generated that excludes any actions that are not in the subset, but that includes the state observation (e.g., the state observation of block 252 in an initial iteration of block 260A1 or a next state observation of block 262 in a subsequent iteration), a description of the task, and the actions of the subset (i.e., the subset determined at a most recent iteration of block 258).

At sub-block 260A2, the system causes the additional prompt to be processed, using the generative model or an additional generative model, to generate further output. The further output can reflect a further subset of the defined actions that are feasible given the task (e.g., based on the description of the task being included in the additional prompt). The further subset of block 260A2 is itself a subset of the most recent iteration of block 258. For example, if the subset of the most recent iteration of block 258 included 5 actions the further subset determined at block 260A2 can include 2 of those 5 actions. As another example, if the subset of the most recent iteration of block 258 included 50 actions the further subset determined at block 260A2 can include 2 of those 50 actions.

At sub-block 260A3, the system explores, in iteration(s), only the action(s) of the further subset, without exploration of any of the action(s) that are not in the further subset. For example, in an initial iteration of sub-block 260A3, rather than exploring all action(s) of the agent, the system only explores the action(s) of the further subset of block 260A2. In some implementations, exploring an action in an iteration of block 260A3 includes performing one or more steps, based on the action, in determining whether the action should be included among a sequence of actions to provide to the agent for performing the task. In some of those or other implementations, exploring an action in an iteration of block 260A3 can include performing sub-block 260AB for the action to generate a predicted next state if the action were to be performed, and using that predicted next state in determining whether to include the action in a sequence of actions to provide to the agent for performing the task.

At sub-block 260B, the system uses action(s) of the subset (of a most recent iteration of block 258) or of the further subset (of a most recent iteration of sub-block 260A2) to generate corresponding predicted next state observation(s). For example, in generating a predicted next state for an action in an initial iteration of block 252, the action and the state observation for the current state can be processed. For example, the action and the state observation for the current state can be processed using a generative model to generate output that reflects the predicted next state observation that is predicted to flow from the performance of the action in the current state. As another example, the state observation for the current state can be used to initialize a simulation of the current state, and the action applied in the simulation to generate the predicted next state.

At block 262, the system determines whether a next state observation has been generated in the current iteration of block 260. If so, then method 200 returns to block 254 and generates another prompt using the generated next state observation. It is noted that, when multiple next state observations are generated in the current iteration of block 260 (e.g., multiple actions are being explored in that iteration), the method 200 can return to block 254 for each of those next state observations (e.g., in parallel). Put another way, multiple iterations of blocks 254, 256, 258, and 260 can be performed in parallel as multiple action-state sequences are being explored.

In response to determining, at block 262, that a next state observation has not yet been generated in the current iteration of block 260, method 200 proceeds to block 264.

At block 264, the system determines if the search and planning process, of iterations of block 260, is complete. If so, the method 200 proceeds to block 266 and the system causes the agent to perform the sequence of actions determined from the task-specific search and planning process of block 260. If not, the method 200 proceeds to block 262 and awaits generation of a next state observation from block 260. In some implementations, causing the agent to perform the sequence of actions at block 266 includes providing command(s) to the agent to cause it to perform the sequence of actions. In some implementations, in determining whether the search and planning process, of iterations of block 260, is complete, the system can determine whether one or more completion criteria have been satisfied. For example, the completion criteria can include exploring a threshold quantity of actions, performing a threshold quantity of calls to a generative model, a threshold duration of time having passed since the start of the search and planning process, the search and planning process having reached a stopping point (e.g., having output a final sequence of actions), and/or satisfaction of one or more other completion criteria.

FIG. 3 schematically depicts an example architecture of a robot 320, which can optionally be utilized in some implementations such as those where the long horizon task is a robotic task. The robot 320 includes a robot control system 360, one or more operational components 330a-330n, and one or more sensors 332a-332m. The sensors 332a-332m may include, for example, vision sensors, light sensors, pressure sensors, pressure wave sensors (e.g., microphones), proximity sensors, accelerometers, gyroscopes, thermometers, barometers, and so forth. While sensors 332a-m are depicted as being integral with robot 320, this is not meant to be limiting. In some implementations, sensors 332a-m may be located external to robot 320, e.g., as standalone units.

Operational components 330a-330n may include, for example, one or more end effectors and/or one or more servo motors or other actuators to effectuate movement of one or more components of the robot. For example, the robot 320 may have multiple degrees of freedom and each of the actuators may control the actuation of the robot 320 within one or more of the degrees of freedom responsive to the control commands. As used herein, the term actuator encompasses a mechanical or electrical device that creates motion (e.g., a motor), in addition to any driver(s) that may be associated with the actuator and that translate received control commands into one or more signals for driving the actuator. Accordingly, providing a control command to an actuator may comprise providing the control command to a driver that translates the control command into appropriate signals for driving an electrical or mechanical device to create desired motion.

The robot control system 360 may be implemented in one or more processors, such as a CPU, GPU, and/or other controller(s) of the robot 320. In some implementations, the robot 320 may comprise a “brain box” that may include all or aspects of the control system 360. For example, the brain box may provide real time bursts of data to the operational components 330a-n, with each of the real time bursts comprising a set of one or more control commands that dictate, inter alia, the parameters of motion (if any) for each of one or more of the operational components 330a-n. In some implementations, the robot control system 360 may perform one or more aspects of method(s) described herein, such as method 200 of FIG. 2.

Although control system 360 is illustrated in FIG. 3 as an integral part of the robot 320, in some implementations, all or aspects of the control system 360 may be implemented in a component that is separate from, but in communication with, robot 320. For example, all or aspects of control system 360 may be implemented on one or more computing devices that are in wired and/or wireless communication with the robot 320, such as computing device 410.

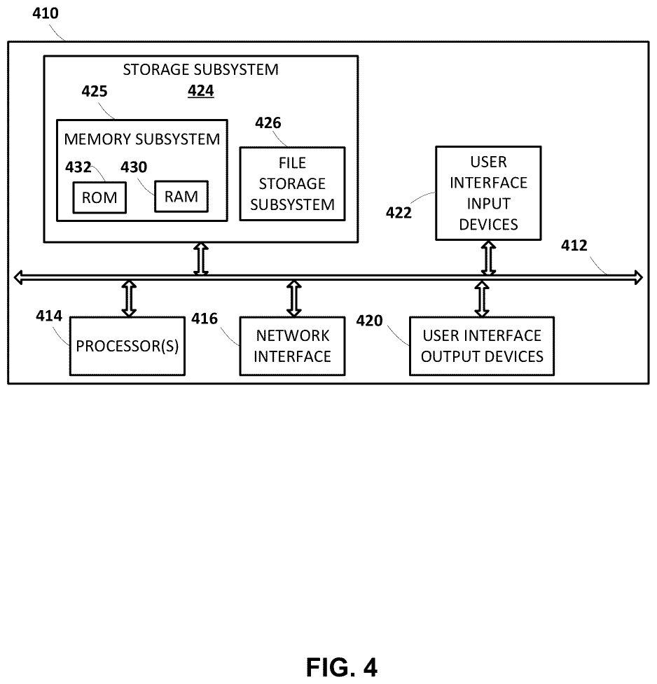

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 200 and/or to implement one or more aspects of system 120 and/or robot 320. Memory 425 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and may include a hard disk drive, a CD-ROM drive, an optical drive, or removable media cartridges. Modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple buses.

Computer system 410 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In some implementations, a method implemented by processor(s) is provided and includes obtaining a state observation reflecting a current state of an environment of an agent. The method also includes generating a prompt including the state observation. The method further includes causing the prompt to be processed using a generative model to generate task-agnostic output reflecting, for multiple actions performable by the agent, a subset of the actions. In response to the task-agnostic output reflecting the subset of the actions, the method includes causing the actions that are in the subset to be utilized, without utilizing any actions that are not in the subset, in at least an initial iteration of performance of a task-specific search and planning process. The task-specific search and planning process determines a sequence of actions to be performed by the agent to accomplish a task. The method further includes causing the agent to perform the sequence of actions determined by performance of the task-specific search and planning process.

These and other implementations of the technology can include one or more of the following features.

In some implementations, causing the actions that are in the subset to be utilized, without utilization of any actions that are not in the subset, in at least the initial iteration of performance of the task-specific search and planning process can include: in the initial iteration, causing an additional prompt to be generated that can include the state observation, that can include a description of the task, that can include the actions that are in the subset, and that can lack any actions that are not in the subset; causing the additional prompt to be processed, using the generative model or an additional generative model, to generate further output that can reflect a further subset of the actions; and restricting exploration, in the initial iteration, to only the further subset of the actions in response to the further subset of the actions being reflected by the further output.

In some implementations, the prompt can lack any description of the task.

In some implementations, causing the actions that are in the subset to be utilized, without utilization of any actions that are not in the subset, can occur only in the initial iteration.

In some implementations, the method can further include, for a given action in the further subset of the actions: generating a next state observation that can reflect a predicted next state of the environment that would result from application of the given action to the current state; generating a further prompt that can include the next state observation; causing the further prompt to be processed using the generative model to generate further task-agnostic output that can reflect, for the multiple actions, a further subset of the actions; and in response to the further task-agnostic output reflecting the further subset of the actions: causing the actions that are in the further subset to be utilized, without utilization of any actions that are not in the subset, in a further iteration of performance of the task-specific search and planning process that can explore further actions to apply to the predicted next state.

In some implementations, causing the actions that are in the further subset to be utilized in the further iteration can include: causing a further prompt to be generated that can include the next state observation, that can include the description of the task, that can include the actions that are in the further subset, and that can lack any actions that are not in the subset; causing the further prompt to be processed, using the generative model or the additional generative model, to generate yet further output that can reflect a yet further subset of the actions; and restricting exploration, in the further iteration, to only the yet further subset of the actions in response to the yet further subset of the actions being reflected by the yet further output.

In some implementations, generating the prompt can include further including, in the prompt, all of the actions. In some of those implementations, including, in the prompt, all of the actions, can include including, in the prompt, respective natural language descriptions that are each descriptive of a corresponding one of the actions.

In some implementations, generating the prompt can include further including, in the prompt, one or more few-shot examples, each of the one or more few-shot examples including a corresponding example state observation and a corresponding subset of the actions that have been determined to be feasible based on the corresponding example state observation.

In some implementations, the state observation can include a natural language description of the current state of the environment of the agent. In some of those implementations, the generative model can be a large language model (LLM).

In some implementations, the generative model can be a vision-language model (VLM). In some of those implementations, the current state observation can include vision data that can capture the environment of the agent.

In some implementations, the agent can be a robotic agent and the environment can be a simulated or physical environment with which the robotic agent interacts.

In some implementations, the agent can be a software application executing on a client device and the environment can include the software application, an additional software application of the client device, and/or an operating system of the client device.

In some implementations, the environment can be a simulated environment.

In some implementations, the task-specific search and planning process can include a Monte Carlo Tree Search (MCTS)-based search process.

In some implementations, causing the actions that are in the subset to be utilized in at least the initial iteration of the task-specific search and planning process can include restricting a search space, of the initial iteration of the task-specific search and planning process, to the actions that are in the subset.

In some implementations, the task-specific search and planning process can: generate, in the initial iteration, a first predicted next state based on processing the current state and a first task-agnostic action in the subset; generate, in the initial iteration, a second predicted next state based on processing the current state and a second task-agnostic action in the subset; and generate, in a subsequent iteration, a third predicted next state based on processing the first predicted next state and a third action; wherein causing the agent to perform the sequence of actions can include causing the agent to perform the first task-agnostic action followed by the third action. In some of those implementations, the task-specific search and planning process can generate a reward, for the sequence of actions, based on the third predicted next state and wherein causing the agent to perform the sequence of actions can include causing the agent to perform the sequence of actions based on the reward satisfying one or more criteria. In some of those or other versions of those implementations, the task-specific search and planning process can utilize the generative model or an additional generative model in: processing the state observation, a description of the task, and the task-agnostic actions in determining to utilize the first task-agnostic action to generate the first predicted next state and to utilize the second task-agnostic action to generate the second predicted next state. In some of those or other versions of those implementations, the method can further include: generating an additional prompt that can include a first predicted next state observation that can reflect the first predicted next state from the task-specific search and planning process; causing the additional prompt to be processed by the generative model to generate additional output that can reflect, for the multiple defined task-agnostic actions, an additional subset of the task-agnostic actions that are feasible in the first predicted next state; in response to the output reflecting the additional subset of the task-agnostic actions: causing the task-agnostic actions that are in the additional subset to be utilized, without utilization of any task-agnostic actions that are not in the additional subset, in the subsequent iteration of the task-specific search and planning process. The third action can be included in the task-agnostic actions of the additional subset but can be excluded from the task-agnostic actions of the subset.

In some implementations, the task-specific search and planning process can include expanding a search tree based on corresponding actions and causing the task-agnostic actions that are in the subset to be utilized in at least the initial iteration of the task-specific search and planning process can include restricting expansions of the search tree to expansions based on the task-agnostic actions that are in the subset.

In some implementations, causing the task-agnostic actions that are in the subset to be utilized serves to reduce an effective branching factor of the search tree maintained by the task-specific search and planning process. By pruning the set of defined actions to only the subset of feasible actions prior to expansion of a node in the search tree, the system maintains a manageable branching factor even as a combinatorial complexity of the environment increases (e.g., as a quantity of manipulatable objects in the environment increases). This allows the search and planning process to scale to tasks with longer horizons or higher complexity without exhausting computational resources, at least relative to utilizing a full world model that expands nodes based on all defined actions.

In some implementations, causing the actions that are in the subset to be utilized, without utilization of any actions that are not in the subset, in at least the initial iteration of performance of the task-specific search and planning process can include: selecting an initial action from the actions that are in the subset; causing an additional prompt to be generated that can include the state observation, and that can include the initial action; causing the additional prompt to be processed, using the generative model or an additional generative model, to generate a next state observation that can reflect a predicted next state of the environment that would result from application of the initial action to the state.

In some implementations, a method implemented by processor(s) is provided and includes obtaining a state observation reflecting a current state of an environment of an agent. The method further includes generating a current state prompt including the state observation, including descriptions of multiple actions performable by the agent, and lacking any description of a task to be performed by the agent. The method includes causing the current state prompt to be processed using a generative model to generate task-agnostic output reflecting, for the multiple actions, a subset of the actions. In response to this task-agnostic output, the method includes generating an initial iteration prompt including the state observation, including a description of the task, including descriptions of the actions of the subset, and lacking descriptions of any actions not included in the subset. The method includes causing the initial iteration prompt to be processed, using the generative model or an additional generative model, to generate task-specific output reflecting, for the actions of the subset, a further subset of the actions. In response to the task-specific output, the method includes generating, for each action of the further subset, a corresponding predicted next state predicted to occur responsive to application of the action to the current state. The method includes selecting a given action, from the actions of the further subset, for inclusion in a sequence of actions to be performed by the agent to accomplish the task. This selection is based on the corresponding predicted next state for the given action.

In some implementations, the method can further include generating a next state prompt that includes a next state observation based on the corresponding next state for the given action, that includes description of the multiple actions that are performable by the agent, and that lacks any description of the task; causing the next state prompt to be processed using the generative model to generate additional task-agnostic output that reflects, for the multiple actions that are performable by the agent, an additional subset of the actions; in response to the additional task-agnostic output reflecting the additional subset of the actions: generating an additional iteration prompt that includes the next state observation, that includes the description of the task, that includes description of the actions of the additional subset, and that lacks description of any of the actions not included in the additional subset; and causing the additional action prompt to be processed, using the generative model or an additional generative model, to generate additional task-specific output that reflects, for the actions of the additional subset, a yet further subset of the actions; in response to the additional task-specific output reflecting the yet further subset of the actions: generating, for each of the actions of the yet further subset, a corresponding predicted next state that can be predicted to occur responsive to application of the action to the predicted next state; and selecting an additional given action, of the additional actions of the further subset, for inclusion in the sequence of actions to be performed by the agent to accomplish the task, wherein selecting the additional given action can be based on the corresponding predicted next state for the additional given action.

In addition, some implementations include one or more processors (e.g., central processing unit(s) (CPU(s)), graphics processing unit(s) (GPU(s)), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer-readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

Some implementations comprise a method of controlling an agent to perform one or more tasks while interacting with an environment. Each task has at least one respective reward associated with performance of the task.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the mechanical agent, e.g. robot, may be interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

Furthermore, the actions utilized in the search and planning process described herein can include temporally extended intents (also referred to as abstract actions, options, or macro-operators). A temporally extended intent specifies, for a given state, a probability distribution over a space of trajectories describing an intended result of executing the intent in the state (e.g., “pick up red block” implies a complex trajectory of joint movements rather than a single atomic motor command). In these implementations, the generative model functions as an intent model to predict the feasibility of these temporally extended intents. The search and planning process can effectively determine whether a specific intent is satisfied to a required degree (e.g., a probability threshold) before expanding that node in the search tree. This allows the system to plan over high-level behaviors rather than primitive time-steps, further reducing the computational burden of the search.

In various implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example, in the case of an autonomous or semi-autonomous land or air or sea vehicle the control signals may define actions to control navigation e.g. steering, and movement e.g., braking and/or acceleration of the vehicle. The actions may be language actions that are in turn used to generate control data to control the robot or other mechanical agent.

In some implementations, the actions performable by the agent can include executable computer code, scripts, or programs synthesized by the generative model. For example, rather than selecting from a fixed list of atomic primitives, the generative model may generate a subset of candidate programs (e.g., Python code snippets or function calls) that represent valid intents for the current state (e.g., a synthesized function to “stack_red_on_blue()”). In some of those implementations, determining the subset of actions includes identifying which synthesized programs are affordable or executable given the current state observation, and the search and planning process explores the consequences of executing these synthesized programs to determine the optimal sequence.

The reward may relate to approaching or achieving one or more target locations, one or more target poses, or one or more other target configurations, e.g. to reward a robot arm for reaching a position or pose. A reward may also be associated with avoiding collision of a part of a mechanical agent with an entity such as an object or wall or barrier. A reward may depend upon any of the previously mentioned observations e.g. robot or vehicle positions or poses. For example in the case of a robot a reward may depend on a joint orientation (angle) or speed/velocity e.g. to limit motion speed, an end-effector position, a center-of-mass position, or the positions and/or orientations of groups of body parts. A reward may also or instead be associated with force applied by an actuator or end-effector, e.g. dependent upon a threshold or maximum applied force when interacting with an object; or with a torque applied by a part of a mechanical agent. In another example a reward may also or instead be dependent upon energy or power usage, excessive motion speed, one or more positions of one or more robot body parts. Where the agent or robot comprises an autonomous or semi-autonomous moving vehicle similar rewards may apply. Also or instead such an agent or robot may have one or more rewards relating to physical movement of the vehicle, e.g. dependent upon energy or power use whilst moving e.g. to define a maximum or average energy use, speed of movement, a route taken when moving e.g. to penalize a longer route over a shorter route between two points, as measured by distance or time. Such an agent or robot may be used to perform a task such as warehouse, logistics, or factory automation, e.g. collecting, placing, or moving stored goods or goods or parts of goods during their manufacture; or the task performed may comprise a package delivery control task. Thus one or more of the rewards may relate these tasks, the actions may include actions relating to steering or other direction control actions, and the observations may include observations of the positions or motions of other agents e.g. other vehicles or robots.

In some implementations the environment is a simulation of the above-described real-world environment, and the agent is implemented as one or more computers interacting with the simulated environment. For example, the simulated environment may be a simulation of a robot or vehicle and the reinforcement learning system may be trained on the simulation and then, once trained, used in the real-world.

In some agent control implementations the agent may be a human agent and the environment may be a real-world environment. For example the agent can be a human user of a digital assistant such as a smart speaker, smart display, or some other device that is used to instruct the user to perform actions. The task may be any real-world task that the user wishes to perform. The observations may be obtained from an observation capture subsystem, e.g. a monitoring system such as a video camera or sound capture system, to capture visual observations of the user performing the task. The actions may comprise instructions in the form of, e.g., text, image, video, or audio data such as speech, that guide the user in performing the task. Thus the observations are observations of a real-world environment in which a human is performing a task, e.g. an image observation from an image sensor and/or a language observation from a speech recognition system; and the actions are language actions that control (instruct) the human, e.g. using natural language or images, to perform actions in the real-world environment to perform the task. A language action may be an action that outputs a natural language sentence, e.g. by defining a sequence of language tokens, e.g. words or wordpieces, to be emitted at sequential time steps. Thus the agent may comprise a user interface device such as a digital device (a “digital assistant”), e.g. a smart speaker or smart display or other device, e.g. with a natural language input and/or output, that controls (instructs) a human user to perform a task. In general such a digital device can be a mobile device with a natural language interface to receive natural language requests from a human user and to provide natural language responses. It may also include a vision based input e.g. a camera and/or display screen. The digital device may include a language model or language generation neural network system either stored locally, or accessed remotely, or both. The user interface device may comprise, e.g., a mobile device, a keyboard (and optionally display), or a speech-based input mechanism, e.g. to input audio data characterizing a speech waveform of speech representing the input from the user in the natural or computer language and to convert the audio data into tokens representing the speech in the natural or computer language, i.e. representing a transcription of the spoken input. The user interface can also include a text or speech-based output, e.g. a display and/or a text-to-speech subsystem. Thus in implementations the agent actions contribute to performing the task. A monitoring system, e.g. a video camera system, may be provided for monitoring the action (if any) which the user actually performs at each time step in case, e.g. due to human error, it is different from the action which the reinforcement learning system instructed the user to perform. The monitoring system can be used to determine whether the task has been completed. Training data may be collected by recording the actions which the user actually performed based on the instruction. The reward value of an action may be generated, for example, by comparing the action the user took with a corpus of data showing a human expert performing the task, e.g. using techniques known from imitation learning, or in some other way, e.g. using a trained reward model. A system of this type can learn how to guide a human to perform a task, e.g. avoiding difficult to perform actions.

In some implementations the environment is a real-world manufacturing environment for manufacturing a product, such as a chemical, biological, or mechanical product, or a food product. As used herein, “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example, the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The reward may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use of a resource the metric may comprise any metric of usage of the resource.

In general, observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples, such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general, the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general, observations of a state of the environment can include any electronic signals representing the functioning of the facility or of equipment in the facility. For example, a representation of the state of the environment may be derived from observations made by any sensors sensing a state of a physical environment of the facility and/or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The reward may relate to a metric of performance of the task. For example in the case of a task to control, e.g. minimize, use of a resource, such as a task to control use of electrical power or water, the metric may comprise any metric of use of the resource.

Some implementations disclosed herein can mitigate (e.g., eliminate) various drawbacks with current techniques. For example, by leveraging a generative model to identify a subset of actions before initiating a search and planning process, the computational burden associated with exploring all possible actions is reduced, addressing the intractability and/or other drawbacks of using LLMs as full world models. For instance, by restricting the search to a finite set of $k$ language-conditioned agent intents that are independently achievable across a task distribution, the planning time ($T_{partial}$) is reduced relative to a full model ($T_{full}$) as a function of the product of probabilities of the affordable trajectories being strictly greater than the product of all potential trajectories in the full state-action space. As another example, focusing the search and planning process on only the feasible actions identified by the generative model improves the accuracy of the planning process by preventing consideration of infeasible actions. As yet another example, the utilization of various techniques disclosed herein allows for generalization across related tasks, improving sample efficiency and reducing the need for extensive data collection for each new task. As yet an additional example, utilizing the generative model to identify the subset of feasible actions serves to bound a prediction error of the partial world model. Large generative models can be prone to hallucinations or inaccuracies when predicting outcomes for arbitrary or infeasible state-action pairs. By restricting the input provided to the generative model during the search and planning process to only the determined subset of feasible actions (e.g., those actions where an associated intent is satisfied to a threshold degree), the system effectively queries the generative model only within a region of competence. This ensures that the utilized partial world model maintains a lower worst-case error rate compared to a full world model that attempts to predict dynamics for the entire state-action space, thereby preventing the search and planning process from being derailed by unrealistic future state predictions.

What is claimed is:

1. A method implemented by one or more processors, the method comprising:
obtaining a state observation that reflects a current state of an environment of an agent;
generating a prompt that includes the state observation;
causing the prompt to be processed using a generative model to generate task-agnostic output that reflects, for multiple actions that are performable by the agent, a subset of the actions;
in response to the task-agnostic output reflecting the subset of the actions:
causing the actions that are in the subset to be utilized, without utilization of any actions that are not in the subset, in at least an initial iteration of performance of a task-specific search and planning process, wherein the task-specific search and planning process determines a sequence of actions to be performed by the agent to accomplish a task; and
causing the agent to perform the sequence of actions determined by performance of the task-specific search and planning process.

2. The method of claim 1, wherein causing the actions that are in the subset to be utilized, without utilization of any actions that are not in the subset, in at least the initial iteration of performance of the task-specific search and planning process comprises:
in the initial iteration:
causing an additional prompt to be generated that includes the state observation, that includes a description of the task, that includes the actions that are in the subset, and that lacks any actions that are not in the subset;
causing the additional prompt to be processed, using the generative model or an additional generative model, to generate further output that reflects a further subset of the actions; and
restricting exploration, in the initial iteration, to only the further subset of the actions in response to the further subset of the actions being reflected by the further output.

3. The method of claim 1, wherein the prompt lacks any description of the task.

4. The method of claim 2 wherein causing the actions that are in the subset to be utilized, without utilization of any actions that are not in the subset, occurs only in the initial iteration.

5. The method of claim 2, further comprising, for a given action in the further subset of the actions:
generating a next state observation that reflects a predicted next state of the environment that would result from application of the given action to the current state;
generating a further prompt that includes the next state observation;
causing the further prompt to be processed using the generative model to generate further task-agnostic output that reflects, for the multiple actions, a further subset of the actions; and
in response to the further task-agnostic output reflecting the further subset of the actions:
causing the actions that are in the further subset to be utilized, without utilization of any actions that are not in the subset, in a further iteration of performance of the task-specific search and planning process that explores further actions to apply to the predicted next state.

6. The method of claim 5, wherein causing the actions that are in the further subset to be utilized in the further iteration comprises:
causing a further prompt to be generated that includes the next state observation, that includes the description of the task, that includes the actions that are in the further subset, and that lacks any actions that are not in the subset;
causing the further prompt to be processed, using the generative model or the additional generative model, to generate yet further output that reflects a yet further subset of the actions; and
restricting exploration, in the further iteration, to only the yet further subset of the actions in response to the yet further subset of the actions being reflected by the yet further output.

7. The method of claim 1, wherein generating the prompt comprises further including, in the prompt, all of the actions.

8. The method of claim 7, wherein including, in the prompt, all of the actions, comprises including, in the prompt, respective natural language descriptions that are each descriptive of a corresponding one of the actions.

9. The method of claim 1, wherein generating the prompt comprises further including, in the prompt, one or more few-shot examples, each of the one or more few-shot examples including a corresponding example state observation and a corresponding subset of the actions that have been determined to be feasible based on the corresponding example state observation.

10. The method of claim 1, wherein the state observation includes a natural language description of the current state of the environment of the agent.

11. The method of claim 1, wherein the state observation includes vision data that captures the environment of the agent.

12. The method of claim 1, wherein the agent is a robotic agent and the environment is a simulated or physical environment with which the robotic agent interacts.

13. The method of claim 1, wherein the agent is a software application executing on a client device and the environment includes the software application, an additional software application of the client device, and/or an operating system of the client device.

14. The method of claim 1, wherein the environment is a simulated environment.

15. The method of claim 1, wherein causing the actions that are in the subset to be utilized in at least the initial iteration of the task-specific search and planning process includes restricting a search space, of the initial iteration of the task-specific search and planning process, to the actions that are in the subset.

16. The method of claim 1, wherein the task-specific search and planning process:
generates, in the initial iteration, a first predicted next state based on processing the current state and a first task-agnostic action in the subset;
generates, in the initial iteration, a second predicted next state based on processing the current state and a second task-agnostic action in the subset; and
generates, in a subsequent iteration, a third predicted next state based on processing the first predicted next state and a third action;
wherein causing the agent to perform the sequence of actions includes causing the agent to perform the first task-agnostic action followed by the third action.

17. The method of claim 16, wherein the task-specific search and planning process generates a reward, for the sequence of actions, based on the third predicted next state and wherein causing the agent to perform the sequence of actions includes causing the agent to perform the sequence of actions based on the reward satisfying one or more criteria.

18. The method of claim 1, wherein the task-specific search and planning process includes expanding a search tree based on corresponding actions and wherein causing the task-agnostic actions that are in the subset to be utilized in at least the initial iteration of the task-specific search and planning process includes restricting expansions of the search tree to expansions based on the task-agnostic actions that are in the subset.

19. The method of claim 1, wherein causing the actions that are in the subset to be utilized, without utilization of any actions that are not in the subset, in at least the initial iteration of performance of the task-specific search and planning process comprises:
selecting an initial action from the actions that are in the subset;
causing an additional prompt to be generated that includes the state observation, and that includes the initial action; and
causing the additional prompt to be processed, using the generative model or an additional generative model, to generate a next state observation that reflects a predicted next state of the environment that would result from application of the initial action to the current state.

20. A method implemented by one or more processors, the method comprising:
obtaining a state observation that reflects a current state of an environment of an agent;
generating a current state prompt that includes the state observation, that includes description of multiple actions that are performable by the agent, and that lacks any description of a task to be performed by the agent;
causing the current state prompt to be processed using a generative model to generate task-agnostic output that reflects, for the multiple actions that are performable by the agent, a subset of the actions;
in response to the task-agnostic output reflecting the subset of the actions:
generating an initial iteration prompt that includes the state observation, that includes a description of the task to be performed by the agent, that includes description of the actions of the subset, and that lacks description of any of the actions not included in the subset; and
causing the initial iteration prompt to be processed, using the generative model or an additional generative model, to generate task-specific output that reflects, for the actions of the subset, a further subset of the actions;
in response to the task-specific output reflecting the further subset of the actions:
generating, for each of the actions of the further subset, a corresponding predicted next state that is predicted to occur responsive to application of the action to the current state; and
selecting a given action, of the actions of the further subset, for inclusion in a sequence of actions to be performed by the agent to accomplish the task, wherein selecting the given action is based on the corresponding predicted next state for the given action.
